(19) United States
(12) Patent Application Publication
(10) Pub. No.: US 2023/0242032 A1
(43) Pub. Date: Aug. 3, 2023

(54) Dunnage Bag Valve Adapter

(71) Applicant: AtMet Group, Inc., Norcross, GA (US)

(72) Inventors: Thomas Keenan, Norcross, GA (US); Wu Qiang, Norcross, GA (US)

(21) Appl. No.: 18/102,523

(22) Filed: Jan. 27, 2023

Related U.S. Application Data
(60) Provisional application No. 63/304,401, filed on Jan. 28, 2022.
(60) Provisional application No. 63/314,909, filed on Feb. 28, 2022.

(51) Int. Cl. B60P 7/06; F16K 15/20; F16K 15/06

(52) U.S. Cl. CPC B60P 7/065; F16K 15/20; F16K 15/063

(57) ABSTRACT

A dunnage bag air valve adapter can be coupled to a dunnage bag air valve to allow a user to inflate the dunnage bag using an inflation tool having an inflation tool head with which the dunnage bag's air valve may be otherwise incompatible.

### CROSS-REFERENCE TO RELATED APPLICATIONS

This application claims priority to U.S. Provisional Patent Application No. 63/304,401, entitled “Dunnage Bag Valve Adapter” and filed on Jan. 28, 2022, which is incorporated herein by reference. This application also claims priority to U.S. Provisional Patent Application No. 63/314,909, entitled “Dunnage Bag Valve Adapter” and filed on Feb. 28, 2022, which is incorporated herein by reference.

### RELATED ART

Inflatable air bags, called “dunnage bags” are frequently used to support or stabilize cargo loads. Such bags are often used to stabilize cargo containers and other items within transport vehicles. This helps prevent cargo from shifting and becoming damaged during the shipping and handling thereof due to the existence or presence of spaces or voids between the cargo.

A user commonly will inflate a dunnage bag using an inflator tool. The user may begin the inflation process by inserting the inflator tool into or couple the inflator tool to a valve of the bag and actuating the inflator tool. Pressurized air will then flow from the inflator tool to the interior of the bag via the dunnage bag's valve.

The user's inflation tool and the dunnage bag's valve must be compatible with one another in order to complete the inflation process properly. Inflation tool and dunnage bag types vary by manufacturer and different types are in use around the world. Improved techniques for ensuring compatibility of a user's inflation tool with a dunnage bag's valve are generally desirable.

### BRIEF DESCRIPTION OF THE DRAWINGS

The disclosure can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 is a three-dimensional perspective view of a dunnage bag in accordance with some embodiments of the present disclosure.

FIG. 2 is a front perspective view of an inflated dunnage bag positioned between cargo in accordance with some embodiments of the present disclosure.

FIG. 3 depicts a first type of dunnage bag air valve and first type of dunnage bag inflation tool in accordance with some embodiments of the present disclosure.

FIG. 4A depicts top view of a first type of dunnage bag air valve in accordance with some embodiments of the present disclosure.

FIG. 4B depicts a cross-sectional view of a first type of dunnage bag air valve taken along and in the direction of line 4B-4B in FIG. 4A in accordance with some embodiments of the present disclosure.

FIG. 5A depicts side view of a head portion of a first type of dunnage bag inflation tool in accordance with some embodiments of the present disclosure.

FIG. 5B depicts a cross-sectional view of a head portion of a first type of dunnage bag inflation tool taken along and in the direction of line 5B-5B in FIG. 5A in accordance with some embodiments of the present disclosure.

FIG. 6A depicts side view of a head portion of a second type of dunnage bag inflation tool in accordance with some embodiments of the present disclosure.

FIG. 6B depicts a cross-sectional view of a head portion of a second type of dunnage bag inflation tool taken along and in the direction of line 6B-6B in FIG. 6A in accordance with some embodiments of the present disclosure.

FIG. 7 depicts a second type of inflator tool and first type of dunnage bag air valve in accordance with some embodiments of the present disclosure.

FIG. 8 is a three-dimensional top perspective view of a dunnage bag air valve adapter in accordance with some embodiments of the present disclosure.

FIG. 9 is a three-dimensional bottom perspective view of a dunnage bag air valve adapter in accordance with some embodiments of the present disclosure.

FIG. 10 is top perspective view of a dunnage bag air valve adapter in accordance with some embodiments of the present disclosure.

FIG. 11 is a bottom perspective view of a dunnage bag air valve adapter in accordance with some embodiments of the present disclosure.

FIG. 12 is a side perspective view of a dunnage bag air valve adapter in accordance with some embodiments of the present disclosure.

FIG. 13 is an additional side perspective view of a dunnage bag air valve adapter in accordance with some embodiments of the present disclosure.

FIG. 14 is an additional side perspective view of a dunnage bag air valve adapter in accordance with some embodiments of the present disclosure.

FIG. 15 is an additional side perspective view of a dunnage bag air valve adapter in accordance with some embodiments of the present disclosure.

FIG. 16 is a three-dimensional perspective exploded view of a dunnage bag air valve adapter and components of a first type of dunnage bag air valve in accordance with some embodiments of the present disclosure.

FIG. 17 depicts alternative embodiments of a dunnage bag air valve adapter in accordance with some embodiments of the present disclosure.

FIG. 18 is a cross-sectional view of a second type of inflator tool in use with a first type of dunnage bag air valve in accordance with some embodiments of the present disclosure.

FIG. 19 is a cross-sectional view of a first type of dunnage bag air valve with adapter in accordance with some embodiments of the present disclosure.

FIG. 20 is a cross-sectional view of a second type of inflator tool in use with an first type of dunnage bag air valve with adapter in accordance with some embodiments of the present disclosure.

FIG. 21 is a flowchart depicting a method 1000 for using a dunnage bag with air valve adapter in accordance with some embodiments of the present disclosure.

### DETAILED DESCRIPTION

### A. Definitions

Unless otherwise defined, all terms (including technical and scientific terms) used herein have the same meaning as commonly understood by one of ordinary skill in the art of this disclosure. It will be further understood that terms, such as those defined in commonly used dictionaries, should be interpreted as having a meaning that is consistent with their meaning in the context of the specification and should not be interpreted in an idealized or overly formal sense unless expressly so defined herein. Well known functions or constructions may not be described in detail for brevity or clarity.

The terms “about” and “approximately” shall generally mean an acceptable degree of error or variation for the quantity measured given the nature or precision of the measurements. Typical, exemplary degrees of error or variation are within 20 percent (%), preferably within 10%, and more preferably within 5% of a given value or range of values. Numerical quantities given in this description are approximate unless stated otherwise, meaning that the term “about” or “approximately” can be inferred when not expressly stated.

It will be understood that when a feature or element is referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments.

The terminology used herein is for the purpose of describing particular embodiments only and is not intended to be limiting. As used herein, the singular forms “a”, “an” and “the” are intended to include the plural forms as well, unless the context clearly indicates otherwise.

Spatially relative terms, such as “under”, “below”, “lower”, “over”, “upper” and the like, may be used herein for ease of description to describe one element or feature's relationship to another when the apparatus is right side up.

The terms “first”, “second”, and the like are used herein to describe various features or elements, but these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the present disclosure.

Terms such as “at least one of A and B” should be understood to mean “only A, only B, or both A and B.” The same construction should be applied to longer list (e.g., “at least one of A, B, and C”).

The term “consisting essentially of” means that, in addition to the recited elements, what is claimed may also contain other elements (steps, structures, ingredients, components, etc.) that do not adversely affect the operability of what is claimed for its intended purpose as stated in this disclosure. Importantly, this term excludes such other elements that adversely affect the operability of what is claimed for its intended purpose as stated in this disclosure, even if such other elements might enhance the operability of what is claimed for some other purpose.

In some places reference is made to standard methods, such as but not limited to methods of measurement. It is to be understood that such standards are revised from time to time, and unless explicitly stated otherwise reference to such standard in this disclosure must be interpreted to refer to the most recent published standard as of the time of filing.

### B. Terms

| | |
|---|---|
| Bag body 4 | Top edge 33 |
| Dunnage bag 5 | Bottom Edge 35 |
| Edge 6 | Cargo 40, 42 |
| Side 7 | Gap 44 |
| Top seam/edge 8 | Valve stem 47 |
| Bottom seam/edge 9 | Nut 48 |
| Inflation Stripes 10, 12, 14 | Pin 49 |
| End 11 | Adapter 50 |
| Stop/Danger stripe 16 | Spring 51 |
| Regions 20, 22, 24 | Valve housing 52 |
| First valve type 30 | Gasket 54 |
| Tab 32 | Valve plate 56 |
| Adapter rim 58 | Fourth embodiment adapter legs 172, 174, |
| Adapter legs 60, 62, 64 | 176, 178 |
| First inflation tool head hub 80 | Adapter hub 201 |
| First inflation tool head tip 81 | Valve stem contact surface 202 |
| First inflation tool head aperture 82 | Coupling contact surface 203 |
| First inflation tool head 90 | First valve surface 204 |
| First valve type 92 | Upper valve stem surface 205 |
| Flap 98 | Interior valve portion 206 |
| Gap 99 | Nozzle surface 208 |
| Second inflation tool head 100 | Coupling aperture 209 |
| Second valve type 102 | Adapter hub bottom surface 210 |
| Second valve air aperture 103 | Adapter hub diameter 211 |
| Second tool head aperture 104 | Adapter hub top surface 212 |
| Second tool head rim 105 | Inflation tool contact surface 220 |
| Second embodiment valve adapter 150 | Airflow 600 |
| Second embodiment adapter legs 152, 154, | Bag exterior environment 700 |
| 156 | Adapter air aperture 702 |
| Third embodiment valve adapter 160 | Housing Aperture 704 |
| Third embodiment adapter legs 162, 164, | Gasket Aperture 705 |
| 166, 168 | Bag interior environment 725 |
| Fourth embodiment valve adapter 170 | |

### C. Dunnage Bag Air Valve Adapter

An adapter may be installed in a dunnage bag air valve to allow a user to inflate the dunnage bag when inflation tools available to the user may be otherwise incompatible with the bag's air valve. The adapter may be configured couple to an element of a dunnage bag air valve, such as a valve stem of a spring-actuated air valve. An inflation tool head may contact and apply pressure to the adapter, which may apply the pressure to the valve stem to compress the spring associated with it and move downward to open the air valve. In this regard, the air valve adapter may allow a user to inflate a dunnage bag when an inflation tool compatible with the air valve of the dunnage bag is not available or when it may be inconvenient or impossible to use a compatible inflation tool.

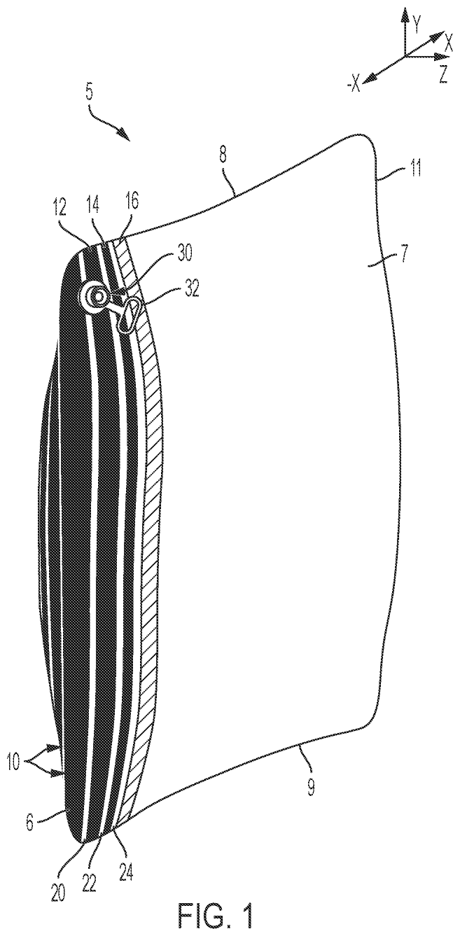

FIG. 1 is a three-dimensional perspective view of a dunnage bag in accordance with some embodiments of the present disclosure. The view of FIG. 1 illustrates an inflated and assembled bag 5 as may be used to secure and support cargo. The exemplary bag 5 of FIG. 1 has a valve 30 for allowing a pressurized fluid to pass into the interior volume of the bag 5. In some embodiments the valve 30 may be a one-way valve configured to prevent fluid from escaping from the bag once inside the bag interior volume, although in some embodiments, the valve may have two-way functionality to allow fluid to leave the inner volume, such as by manually actuating the valve to reduce internal pressure. In some embodiments, the fluid may be air (e.g., CAS No. 132259-10-0), but in some embodiments, the bag may be inflated using other fluids in other embodiments.

The bag 5 also includes tab 32 for aiding a user in transporting the bag 5.

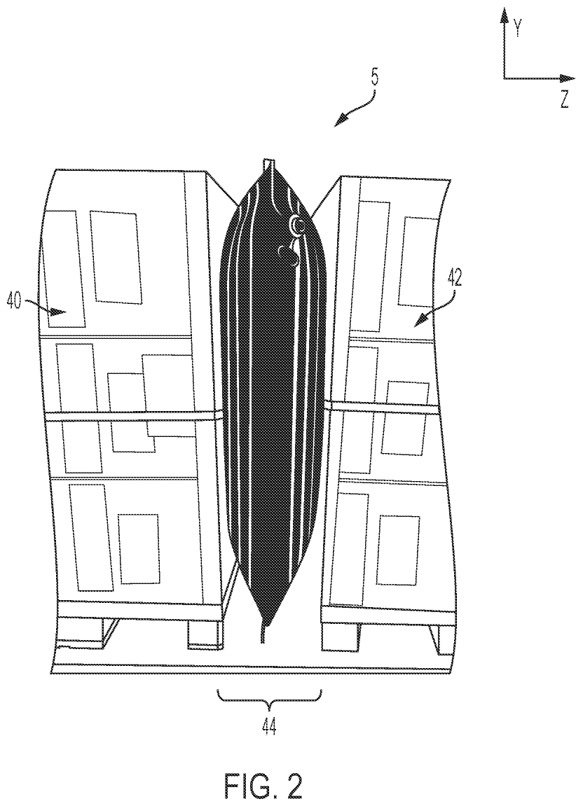

FIG. 2 is a front perspective view of an inflated dunnage bag positioned between cargo in accordance with some embodiments of the present disclosure. The dunnage bag 5 has been inflated and positioned in a gap 44 between cargo 40 and 42.

Additional aspects of dunnage bags and valve adapters are described in U.S. Provisional Patent Application No. 63/194,775 filed May 28, 2021 and entitled “Dunnage Bag with Graduated Inflation Stripes” and U.S. Provisional Patent Application No. 63/304,401 filed Jan. 28, 2022 and entitled “Dunnage Bag Valve Adapter”. Each of the foregoing applications is incorporated by reference herein.

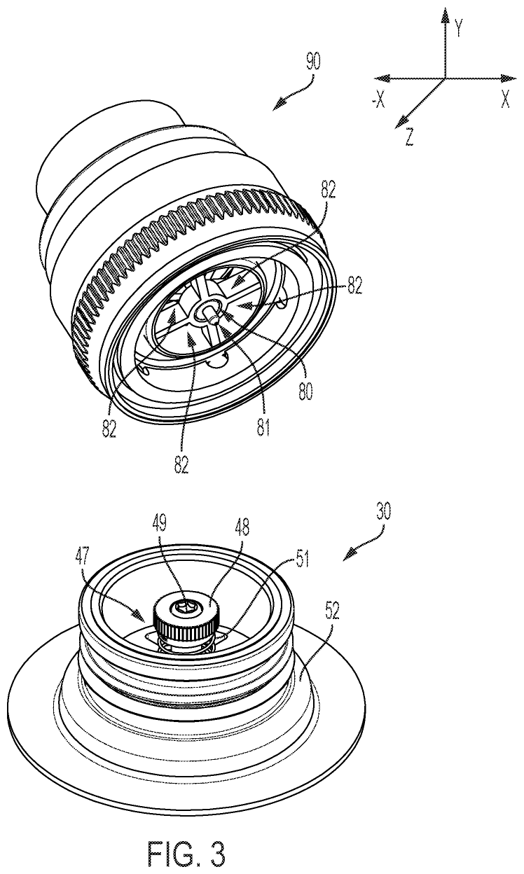

FIG. 3 depicts a first type of dunnage bag air valve 30 and first type of dunnage bag inflation tool head 90 in accordance with some embodiments of the present disclosure. The first type inflation tool head 90 is configured to make contact with the valve 30 and certain of its components to open the valve 30 and communicate pressurized fluid (in the context of this document, pressurized air, although other pressurized fluids are possible and contemplated herein) from a pressure source to an interior of the dunnage bag 5 via the valve 30. This may occur until a desired pressure within the bag is achieved, thereby inflating the bag.

The head 90 has a central hub 80 and tip 81, as well as a plurality of air apertures 82. The tip 81 protrudes from the hub 80 and together with the hub 80 may make contact with components of the valve 30, as described below. The pressurized fluid may pass through one or more of the air apertures 82 and into and through valve 30. Although a particular number of apertures 82 is depicted in FIG. 3, in some embodiments, the tool head 90 may have as little as a single air aperture 82 or more than one air aperture 82.

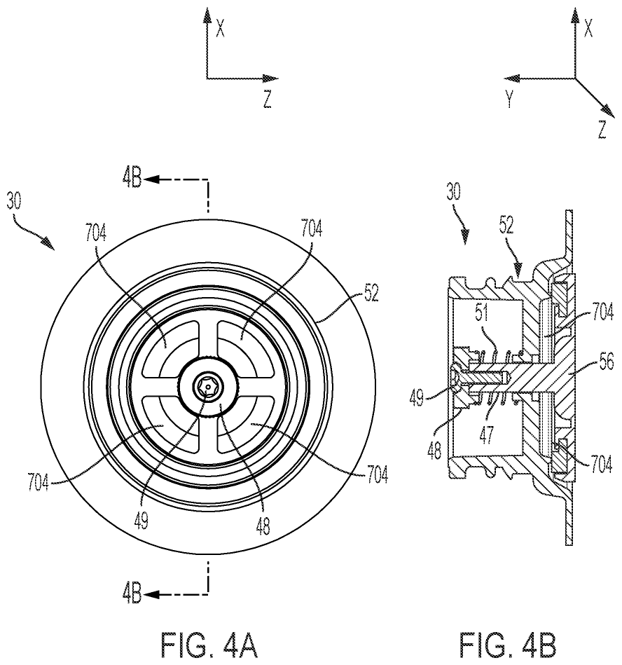

Additional operation of the valve 30 is described below with regard to FIG. 4.

The tool head 90 opens the valve 30 when the tool head 90 is coupled to it. One or more of a hub 80, pin 81 or other component of the head 90 applies a pressure to one or more of the pin 49, nut 48, or stem 47 in order to push the stem 47 along a longitudinal axis of the stem 47. Pressure applied to the stem 47 may open the valve 30 by pushing the stem 47 downward and compressing the spring 51. When the stem 47 moves downward, it pushes plate 56 downward, creating a gap between the plate 56 and an interior valve portion 206 inside the bag 5. In this regard, pressurized air may flow through the apertures 702, and the valve 30 is “open.” When the tool 90 is decoupled from the valve 30, the spring 51 may apply pressure to a bottom surface of the nut 48 to return the stem 47 and gate 56 to their original positions. When the gap between plate 56 and interior portion of the valve housing closes so that no more pressurized air may flow through the apertures 702, the valve 30 is “closed.” In this regard, the components of the inflation tool head 90 interact with components of the valve 30 to open and close the valve without additional action required by a user beyond coupling the tool head 90 to the valve 30.

A surface of the hub 80 may contact a surface of one or more portions of the valve 30, such as a portion of one or more of stem 47, nut 48 and pin 49. A pressure sufficient to compress the spring 51 may be exerted on the stem 47 (e.g., via one or more of hub 80 and tip 81) when the tool head 90 is coupled to the valve 30.

Note that the tool head 90 may have an interior portion configured to couple to an exterior portion of the housing 52, such as by interlocking tabs, threads, grooves, etc., and thereby improve connection between tool head 90 and the valve housing 52. When the tool head 90 is coupled to the housing 52 this may prevent decoupling of the tool head 90 from housing 52 while the bag 5 is being inflated.

Note also that the operation of the valve 30 described herein is exemplary and not limiting of this disclosure. It will be understood upon reading of this disclosure that the air valve adapter described herein may be installed and used to translate a location of force from a surface of an inflation tool head to a member of an air valve that must be compressed or moved in order to open the valve and inflate the dunnage bag.

In some embodiments, a downward (in the negative Y-axis direction) pressure must be applied to the spring-loaded valve stem 47 in order to open a first type dunnage bag air valve 30. Spring 51 holds the valve 30 closed by pushing the nut 48 and valve stem 47 upward (in the positive Y-axis direction) so that no pressurized air passes between the valve plate 56 and interior valve portion 206 (a portion of the valve with which the valve plate 56 is in contact).

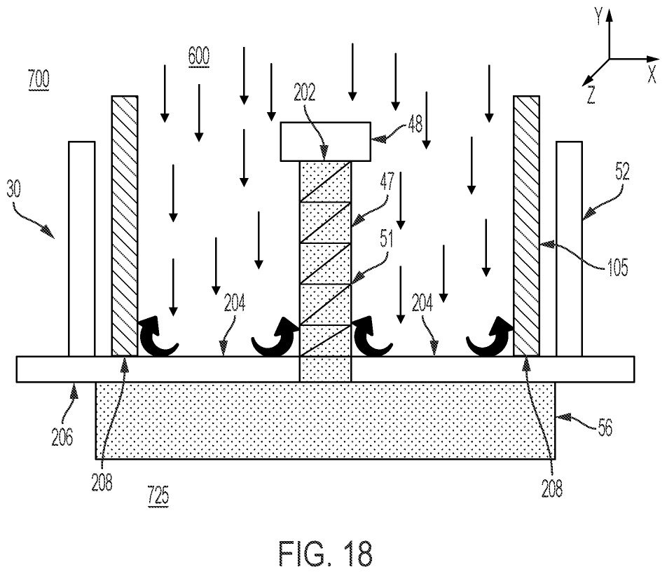

The first type inflation tool head 90 has one or more components (e.g., first inflation tool head hub 80, first inflation tool head tip 81) positioned to open the valve 30 automatically when the head 90 and valve 30 are coupled together (e.g., by coupling head 90 to valve housing 52). The components of head 90 may apply sufficient pressure to open the valve to one or more components of the valve 30, such as nut 48, pin 49 and valve stem contact surface 202 of valve stem 47. When the valve stem 47 moves downward, a gap (not specifically shown in FIG. 18) is created between the valve plate 56 and the interior valve portion 206 inside the interior of the bag body 4 so that air can flow through apertures 704 into the bag 5. The head 90 and valve 30 can remain coupled together while such pressure is applied, so that pressurized air cannot escape from between the tool head 90 and valve 30, essentially all of the pressurized air can pass through the open valve 30 and into the bag interior.

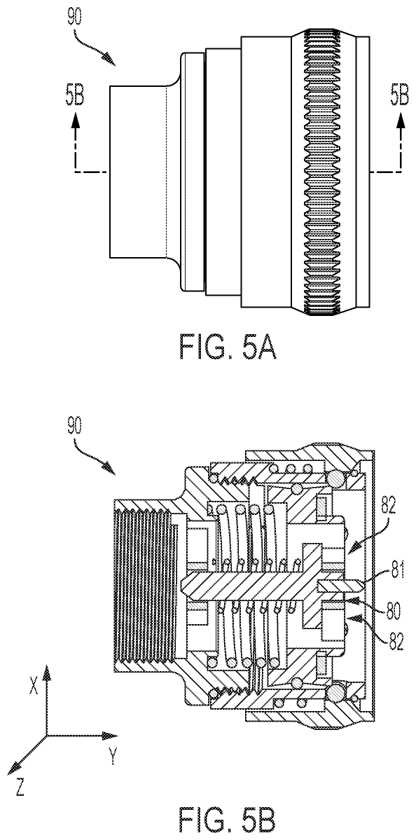

FIG. 4A depicts top view of a first type of dunnage bag air valve, and FIG. 4B depicts a cross-sectional view of a first type of dunnage bag air valve taken along and in the direction of line 4B-4B in FIG. 4A. FIG. 5A depicts side view of a head portion of a first type of dunnage bag inflation tool and FIG. 5B depicts a cross-sectional view of a head portion of a first type of dunnage bag inflation tool taken along and in the direction of line 5B-5B in FIG. 5A.

The valve 30 has a stem 47, nut 48, pin 49 and spring 51. The foregoing elements of the valve 30 may be disposed within circular housing 52.

Stem 47 may be centrally located within the valve 30, and pass from an interior of the valve housing 52 through the bag body 4 and couple to a valve plate 56. The stem 47 and plate 56 may act in conjunction with one another to open and close the valve 30. In some embodiments, the stem 47 and plate 56 may be configured to move upward and downward with respect to the valve housing 52. In the context of this document, the terms “upward” and “downward” may refer to movement or orientation with respect to the y-axis direction of travel. Similarly, the terms “top” and “bottom” may refer to positioning of respective elements with regard to the y-axis direction.

The nut 48 may be any of various types of components, such as a traditional threaded nut, bushing, or other component capable of better securing the pin 49 to the stem 47 and receiving pressure from the first inflation tool hub 80, head tip 81 on its top side, and spring 51 on its underside. In this regard, the nut 48 may have a diameter that is wider than the diameter of the valve stem 47 and configured to receive pressure from spring 51 to keep the valve normally closed, and to open the valve when pressure is applied to the nut 48, such as by a first type inflation tool head 90 or a valve adapter as described herein.

The pin 49 may be any of various types of fasteners for coupling the nut to the stem 47. The pin 49 may be a threaded fastener, but various types of couplers (e.g., rivets, screws, bolts, etc.) may be suitable in some embodiments. The pin 49 may be removable, and may be installed to couple an adapter to the stem 47 as described further below.

Spring 51 may be disposed around the stem 47, and may be in contact with the first valve surface 204 and one or more of the nut 48 or a valve adapter (described below). In some embodiments, the spring 51 may be disposed around stem 47, and may apply pressure to an underside of the adapter (e.g., adapter hub bottom surface 210) or nut 48 in order to push the valve stem 47 upward and, thus, valve plate 56 against the interior valve portion. The spring 51 may be various types of springs suitable for use in an air valve. Similarly, the spring 51 may have a stiffness or spring coefficient corresponding to an amount of pressure needed to keep air from passing through the valve when the bag is inflated, but also allowing tool head 90 to compress it when applying pressure to the stem 47 during inflation of the valve 30.

The plate 56 may have a size, shape and features configured to close or seal one or more of the valve housing apertures 704. In some embodiments, the plate 56 may correspond to features of each housing aperture 704 so that it seals them when in contact with the interior of valve portion 206. The plate may be coupled to the stem 47 or in some embodiments, may be a distal part of the stem 47.

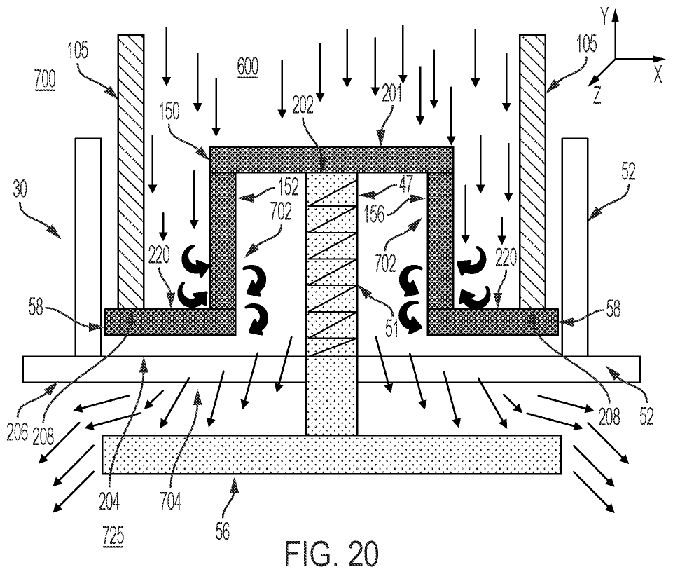

To better illustrate operation of the valve, when the stem 47 is in a first position, an upper valve stem surface 205 of the stem 47 may be at its furthest distance from the first valve surface 204. In this regard, the plate 56 may be positioned against the interior valve portion 206 to seal or block one or more apertures 704, so that no air passes between the gate and interior valve portion (see FIG. 20) and into the bag interior environment 725. In this position, the valve 30 may be considered “closed” (e.g., no air passes through the valve from apertures 704 and through a gap in gate 56 and interior valve portion 206).

When the stem 47 is in a second position, an upper valve stem surface 205 of the stem 47 may be sufficiently closer to the first valve surface 204 than in the first position to open the valve 30. In this regard, a gap may be opened between plate 56 and interior valve portion 206 to allow air to flow from one or more apertures 704. In this regard, air may pass between the gate and interior valve portion (see FIG. 20) and into the bag interior environment 725. In this position, the valve 30 may be considered “open” (e.g., air passes through the valve from apertures 704 and through a gap in gate 56 and interior valve portion 206).

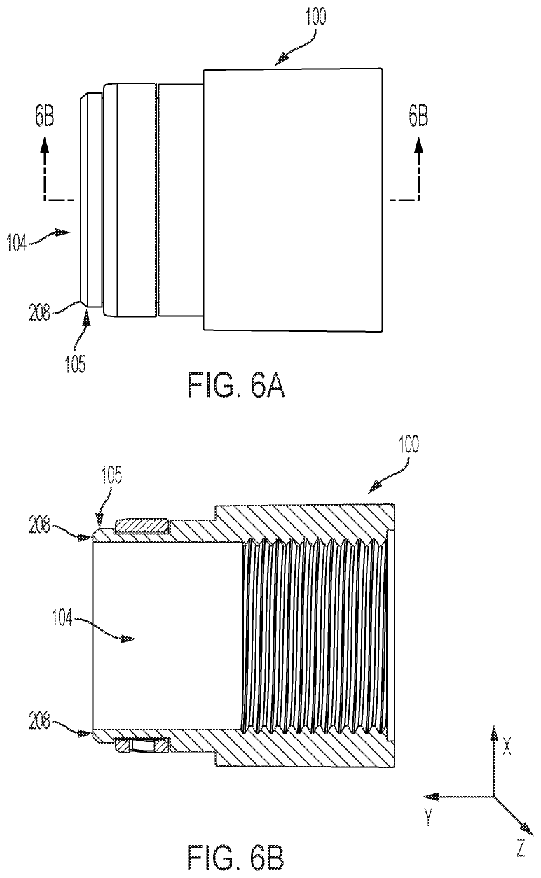

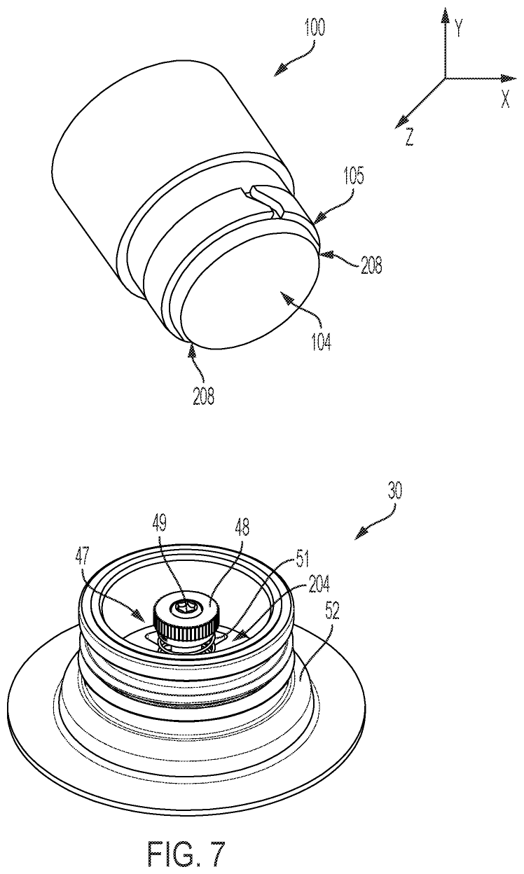

FIG. 6A depicts side view of a head portion of a second type of dunnage bag inflation tool, and FIG. 6B depicts a cross-sectional view of a head portion of a second type of dunnage bag inflation tool taken along and in the direction of line 6B-6B in FIG. 6A. FIG. 7 depicts a second type of inflator tool and first type of dunnage bag air valve in accordance with some embodiments of the present disclosure.

A second type inflation tool head 100 may generally be suitable for use with valve types (e.g., second valve type 102) in which force exerted by pressurized air is applied to the valve to open the air valve and allow air to move into the interior of the bag. Inflation tools having heads such as inflation tool head 100 typically may not be compatible for use with air valves incorporating a stem such as valve 30 because the tool head 100 lacks components to apply pressure to the stem 47 and open the valve 30.

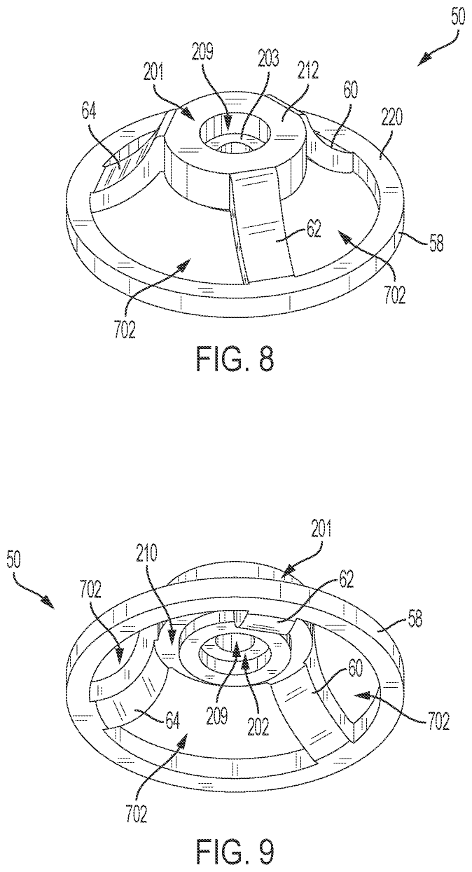

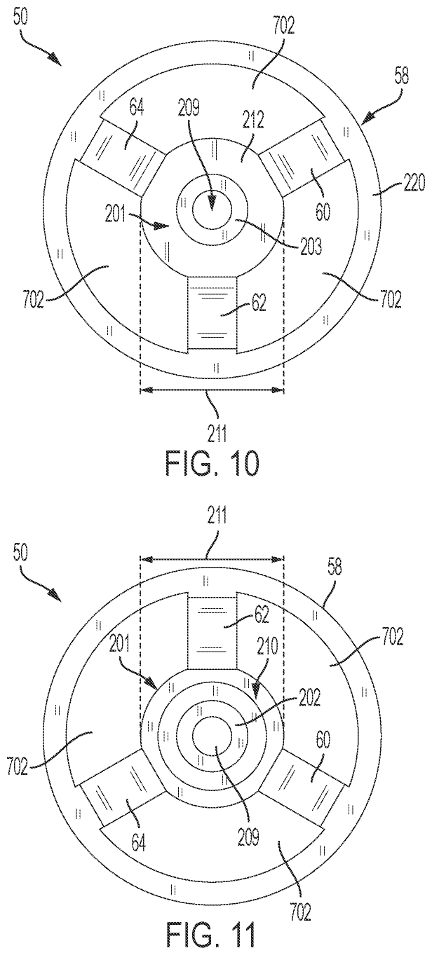

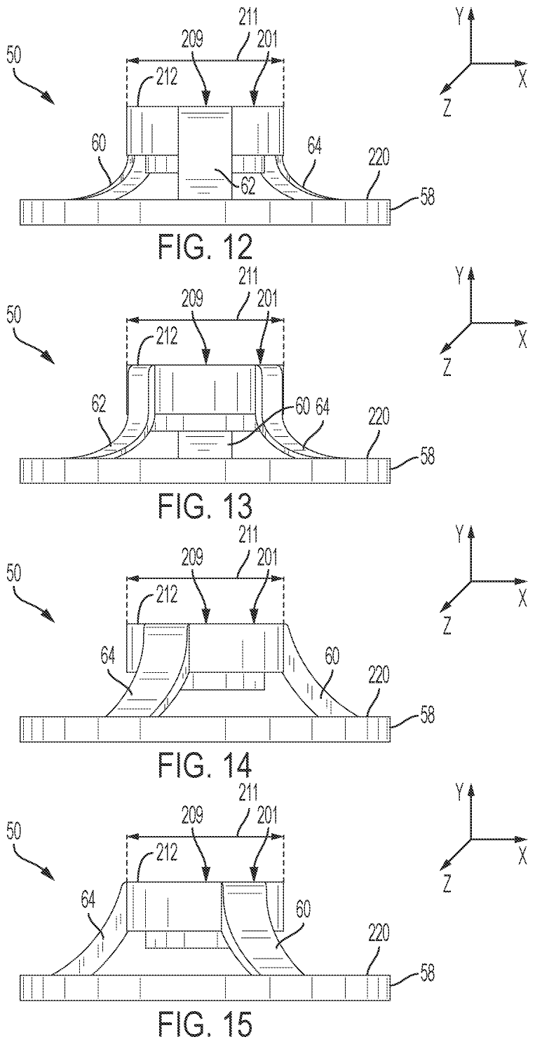

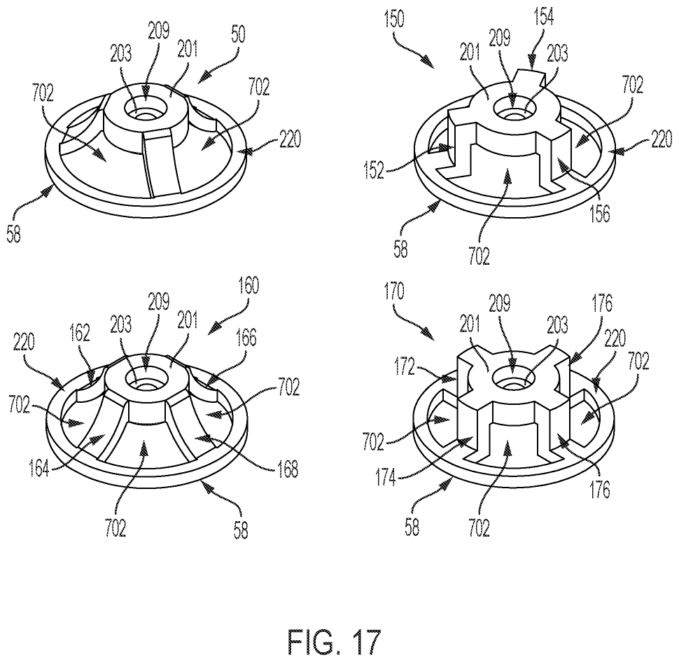

The adapter 50 depicted in FIGS. 8-15 is one embodiment of a dunnage bag air valve adapter. Other embodiments are contemplated and disclosed herein, and it will be understood that features of the adapter 50 may be shared by other embodiments of a dunnage bag air valve adapter such as those shown in FIG. 17 and the attached Appendix, which is hereby incorporated by reference in its entirety.

FIGS. 8-15 depict various views of a dunnage bag air valve adapter in accordance with some embodiments of the present disclosure.

The valve adapter 50 has an adapter rim 58 coupled to an adapter hub 201 by legs 60, 62, 64. Apertures 702 are positioned between legs and configured to allow air to flow through the apertures 702 when installed on a valve stem 47. Although a specific number of apertures is depicted in the figures, it will be understood that various numbers of apertures may be possible in some embodiments.

The adapter rim 58 is configured to receive force or pressure from a second type tool head rim 105 when inserted into the valve 30 for inflating the bag 5. Inflation tool contact surface 220 may be a top surface of the adapter rim 58. The inflation tool contact surface 220 may comprise a surface profile corresponding to a surface 208 of a rim 105 of the inflation tool 100. In some embodiments, the surface profile may be one or more of: flat, curved, notched, slotted and grooved. Other configurations for the surface 220 and adapter rim 58 are possible in some embodiments.

Legs 60, 62 and 64 may be configured to translate the force from the adapter rim 58 to the adapter hub 201. The legs 60, 62, and 64 are depicted as having a curved profile, but other profiles and shapes of legs are possible in some embodiments. In addition, an adapter may have various numbers of legs connecting the adapter rim 58 to the hub 201, even though three legs are shown in FIGS. 8-15. Additional detail is shown in FIG. 17 and the attached Appendix.

The adapter hub 201 has a valve stem contact surface 202, coupling contact surface 203, and coupling aperture 209. Other components are possible in other embodiments.

The adapter hub 201 is depicted as having a circular cross section in the figures, but may have other cross sectional profiles or shapes in other embodiments. The adapter hub 201 may have an adapter hub diameter 211 that is greater than that of the stem 47. The adapter hub 201 may have a valve stem contact surface 202 configured to make contact with the upper valve stem surface 205 of valve stem 47. The valve stem contact surface 202 may be positioned within a diameter 211 of the adapter hub 201, and adjacent to a bottom surface 210 of the adapter hub.

The adapter hub 201 may have an adapter hub top surface 212 and an adapter hub bottom surface 210. The top surface 212 may have features configured to allow use with a first type inflation tool head 90 (e.g., features corresponding to the hub 80 and tip 81). In this regard, when the adapter is installed, the valve 30 may be compatible for inflation via an inflation tool having either of the first type tool head 90 or second type tool head 100. The bottom surface 210 may be configured to receive pressure from spring 51 to keep the valve normally closed, and to open the valve when pressure is applied to the adapter 50, such as by a tool head 100 or a valve adapter as described herein. The spring 51 may make contact with and apply pressure to other portions of the adapter in some embodiments.

A coupling contact surface 203 may be configured to make contact with a coupler or fastener, such as pin 49, and may be positioned within a diameter 211 of the adapter hub 201 and may be positioned adjacent to a top surface 212 of the adapter hub 201. The fastener or coupler may pass through coupling aperture 209 and into an aperture of the stem 47 (not specifically shown in FIGS. 8-15). The coupling aperture 209 also may be positioned within a diameter 211 of the adapter hub 201. A portion of the adapter hub 201 surrounding the coupling aperture 209 may be threaded or otherwise configured to enhance coupling of the adapter to the stem 47. Further, coupling aperture 209 and the hub 201 may be configured to accommodate nut 48 or other components of the stem 47 in order to achieve the functionality ascribed herein to the adapter and valve.

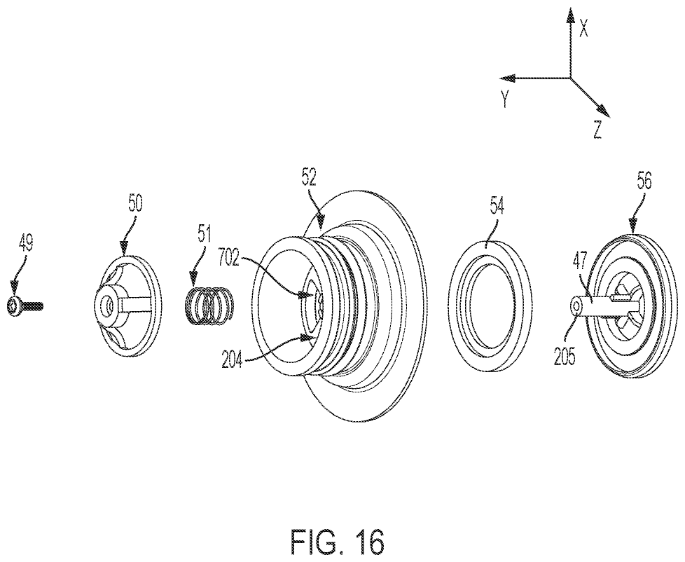

FIG. 16 is a three-dimensional perspective exploded view of a dunnage bag air valve adapter and components of a first type of dunnage bag air valve in accordance with some embodiments of the present disclosure. The figure shows an adapter 50 and additional detail of first type dunnage bag air valve components, including pin 49, spring 51, housing 52, gasket 54, stem 47 and plate 56.

To install the adapter 50 on a first type air valve 30, an exemplary method may be performed. A user may remove the pin 49 from the valve, such as by unscrewing the pin from the stem 47 and nut 48 (not specifically shown in FIG. 16). In some embodiments, the adapter 50 may be configured to accommodate nut 48, but in the embodiment of FIG. 16, the nut 48 is removed, and the adapter 50 is positioned in contact with the upper valve stem surface 205. The spring 51 may be compressed in order to allow the adapter to make contact with the stem surface 205. Stem 47 passes through an interior portion of the gasket 54, housing 52 and spring 51 to make contact with the adapter 50. Once the adapter is in contact with the surface 205, the pin 49 may be reinserted or otherwise recoupled to the stem 47. Thereafter, the adapter is ready for use with inflation tools having either first or second type inflation tool heads.

FIG. 17 depicts alternative embodiments of a dunnage bag air valve adapter in accordance with some embodiments of the present disclosure. The figure depicts four exemplary adapter embodiments: two with curved legs, and two with square, stepped or “angled” legs. Adapters 50 and 160 each have curved legs: adapter 50 is essentially the same adapter as shown in great detail in FIGS. 8-15, as is adapter 160 but for the addition of an additional leg (to give adapter 160 four legs 162, 164, 166 and 168). The remaining features of the adapter 50 and 160 are essentially the same as described with regard to discussion of adapter 50 above.

Similarly, adapters 150 and 170 each have angled legs: the adapters are essentially the same adapter as shown in great detail in FIGS. 8-15, except adapter 150 has angled legs, and adapter 170 has an additional leg (to give adapter 170 four legs 172, 174, 176, 178). The remaining features of the adapter 150 and 170 are essentially the same as described with regard to discussion of adapter 50 above.

The following figures provide cross-sectional views of a first type dunnage bag air valve 30 that has been simplified for the viewer's convenience. FIG. 18 is a cross-sectional view of a second type of inflator tool in use with a first type of dunnage bag air valve in accordance with some embodiments of the present disclosure.

As noted above, a downward (in the negative Y-axis direction) pressure must be applied to the spring-loaded valve stem 47 in order to open a first type dunnage bag air valve 30. Spring 51 holds the valve 30 closed by pushing the nut 48 and valve stem 47 upward (in the positive Y-axis direction) so that no pressurized air passes between the valve plate 56 and interior valve portion 206 (a portion of the valve with which the valve plate 56 is in contact).

A first type inflation tool head 90 has one or more components (e.g., first inflation tool head hub 80, first inflation tool head tip 81) positioned to open the valve 30 automatically when the head 90 and valve 30 are coupled together (e.g., by coupling head 90 to valve housing 52). The components of head 90 may apply sufficient pressure to open the valve to one or more components of the valve 30, such as nut 48, pin 49 and valve stem contact surface 202 of valve stem 47. When the valve stem 47 moves downward, a gap (not specifically shown in FIG. 18) is created between the valve plate 56 and the interior valve portion 206 inside the interior of the bag body 4 so that air can flow through apertures 704 into the bag 5. The head 90 and valve 30 can remain coupled together while such pressure is applied, so that pressurized air cannot escape from between the tool head 90 and valve 30, essentially all of the pressurized air can pass through the open valve 30 and into the bag interior.

A second type inflation tool head 100 may generally be suitable for use with valve types (e.g., second valve type 102) in which force exerted by pressurized air is applied to the valve to open the air valve and allow air to move into the interior of the bag. Inflation tools having heads such as inflation tool head 100 typically may not be compatible for use with air valves incorporating a stem such as valve 30 because the tool head 100 lacks components to apply pressure to the stem 47 and open the valve 30.

FIG. 18 illustrates this problem. A second type tool head 100 is inserted into a first type valve 30. The second type tool head rim 105 is in contact with the valve surface 204, but the tool head 100 lacks components to apply pressure to compress the stem 47 and open the valve 30 (e.g., there is no gap between valve plate 56 and interior valve portion 206). Pressurized airflow 600 is thus unable to pass from the bag exterior environment 700 into the bag interior environment 725.

Thus, absent modification, an inflation tool having a second type inflation tool head 100 is generally incompatible with a dunnage bag having a first type air valve 30.

In order to address this problem, a dunnage bag air adapter may be coupled to the valve 30 to allow an inflation tool having a second type tool head 100 to apply pressure to compress the stem 47 and open the valve 30.

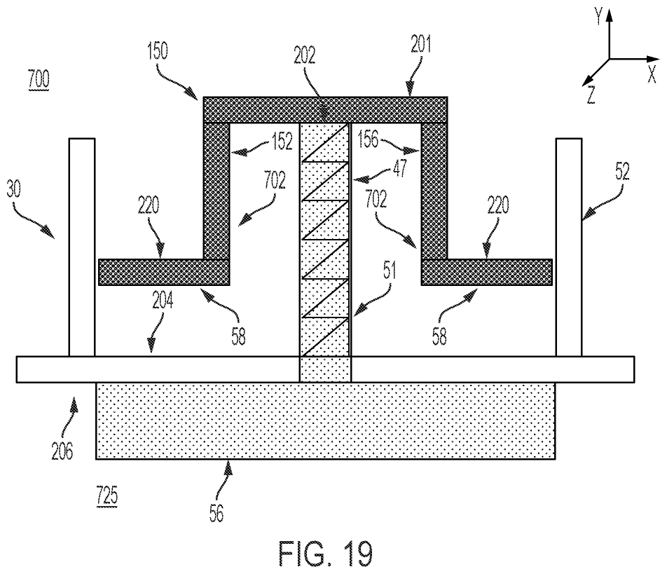

FIG. 19 is a cross-sectional view of a first type of dunnage bag air valve with adapter in accordance with some embodiments of the present disclosure. In some embodiments, the adapter may be installed in the air valve using a method similar or the same as the method described with regard to FIG. 16 above. Other techniques are possible in other embodiments.

The adapter 150 is coupled to an upper portion of the valve stem 47 and positioned to receive pressure from tool head 100 and provide such pressure to the valve stem 47. In the embodiment of FIG. 19, the adapter is depicted as a second embodiment valve adapter 150 for ease of visualization, but it will be appreciated that other embodiments of valve adapter will have the same or similar functionality when used in essentially the same manner as the adapter shown in FIGS. 19 and 20.

The adapter 150 has essentially the same features as the adapter 150 shown in FIG. 14, including stepped legs 152, 154, 156, a coupling aperture 209 (not specifically shown), valve stem contact surface 202, and coupling contact surface 203 (not specifically shown). The adapter 150 further has an essentially circular adapter rim 58 and inflation tool contact surface 220.

The adapter 150 is coupled to an uppermost portion of the stem 47, such that the valve stem contact surface 202 of the adapter 150 is in contact with upper valve stem surface 105.

The spring 51 may keep the valve 30 closed when the adapter 150 is installed in much the same way it does when the adapter is not installed. In some embodiments, the spring 51 may apply pressure to one or more of an underside of the adapter (e.g., adapter hub bottom surface 210) or nut 48 in order to push the valve stem 47 upward and, thus, close the valve by pushing the valve plate 56 against the interior valve portion 206.

After the adapter 150 has been installed in the valve 30 as shown in FIG. 19, the valve 30 is ready for inflation by an inflation tool using either a first type tool head 90 or second type tool head 100. FIG. 20 is a cross-sectional view of a second type of inflator tool in use with a first type of dunnage bag air valve with adapter in accordance with some embodiments of the present disclosure.

Second type inflation tool head 100 is inserted within the valve housing 52. Rim 105 of the tool head 100 is in contact with the adapter 150. More specifically, nozzle surface 208 of rim 105 is in contact with the inflation tool contact surface 220 of rim 58. The valve stem contact surface 202 of adapter hub 201 may be in contact with the upper valve stem surface 205 (not specifically shown) of valve stem 47.

A pressure is being applied to the tool head 100, and to the inflation tool contact surface 220 and rim 58 of the adapter 150.

Because the adapter 150 may be essentially rigid, as described herein, a portion (which may be some or all) of the pressure applied by the inflation tool head 100 to the surface 220 and rim 58 is translated by legs 152 and 156 to the hub 201. In this regard, the adapter hub 201, and specifically the valve stem contact surface 202, applies pressure to the valve stem 47 (upper valve stem surface 205) with which it is in contact.

As depicted in FIG. 20, when pressure applied to valve stem 47 via the adapter 150 and tool head 100 is sufficient to compress spring 51 (e.g., by exceeding a pressure threshold associated with the spring coefficient of spring 51) and displace the valve stem 47 from the first position to the second position. In this regard, when the valve stem 47 moves from the first position to the second position, the valve opens, and air from the pressurized airflow 600 provided by the inflation tool may pass through adapter air apertures 702, through housing aperture 704 and gasket aperture 705 (not specifically shown in FIG. 20), and into the bag interior environment 725. This may allow inflation of the bag until a desired internal bag pressure is achieved.

When the tool head 100 is removed, or when pressure applied to valve stem 47 via the adapter 150 and tool head 100 is not sufficient to compress spring 51 (e.g., by failing to exceed the pressure threshold associated with the spring coefficient of spring 51), the spring 51 may return the valve stem 47 to the first position, and the valve may close.

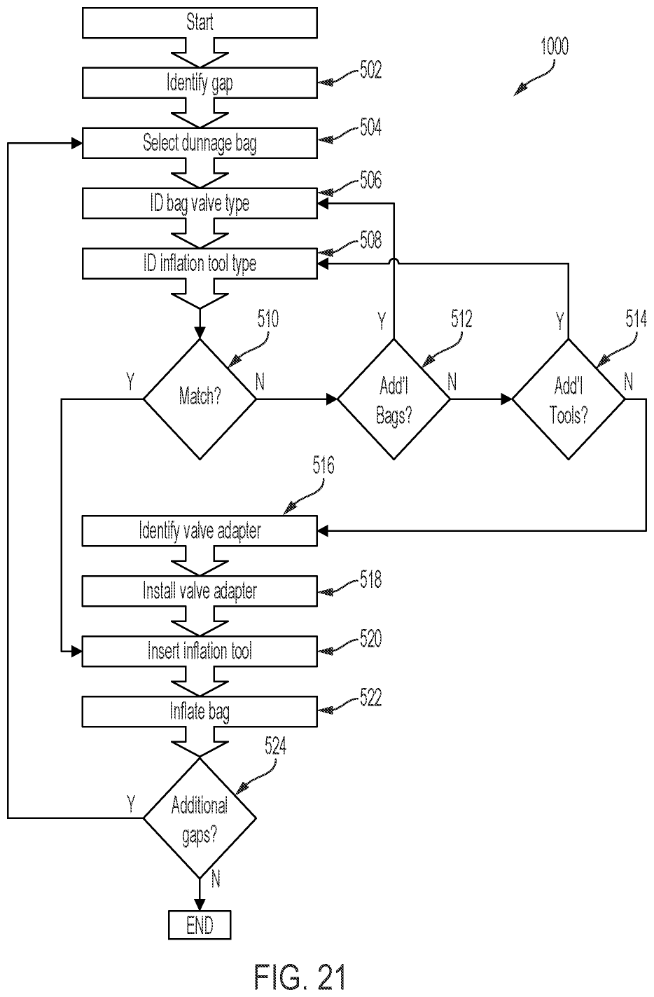

FIG. 21 is a flowchart depicting a method 1000 for using a dunnage bag with air valve adapter in accordance with some embodiments of the present disclosure.

The method may begin at step 502 when a user identifies a gap between cargo that should be braced by a dunnage bag. The user may identify such gap based on guidelines, regulatory requirements, personal judgment, or otherwise. Once a gap is identified, processing may proceed to step 504, where the user may select a dunnage bag for use in the identified gap.

After a user has selected a dunnage bag to use in the gap, processing may continue to step 506, where the user may identify a type of air valve of the dunnage bag. The user may retrieve the valve type by various methods, including by visual inspection, referencing information about the specific dunnage bag, or otherwise, and once the user has identified the type of valve installed on the dunnage bag (e.g., first type air valve or second type air valve), processing may continue to step 508, where a user may identify a type of inflation tool available. The inflation tool type may refer to various characteristics of inflation tools, but in some embodiments, may refer to inflation tool head type, such as a first type inflation tool head and second type inflation tool head. Thereafter, processing may proceed to step 510.

At step 510, the user may compare the selected inflation tool type with the air valve type on the selected dunnage bag. In some embodiments, the user may compare type of inflation tool head with air valve type. If the type of inflation tool head matches (e.g., is compatible with) the valve type, processing may proceed to step 520 where the user may insert the inflation tool and then to step 522, where the user may inflate the bag.

If the user determines that the type of inflation tool head does not match the valve type, processing may proceed to step 512, where the user may determine whether there are additional dunnage bags that may have compatible air valves. If so, processing may return to step 506. If not, processing may continue to step 514, where the user may determine whether there are additional inflation tools available for use that may have inflation tool heads compatible with the air valve of the available dunnage bag. If so, processing may return to step 508. If not, processing may proceed to step 516.

At step 516, the user may identify a suitable valve adapter to install in the air valve that will allow the user to inflate the dunnage bag using the available inflation tool. In some embodiments, when the air valve is a first type air valve and the user has an inflation tool having a second type inflation tool head, the user may select an air valve adapter having features and characteristics similar to those described herein with respect to the adapter for use with the first type air valve. Once the user has identified a suitable air valve adapter, processing may proceed to step 518, where the user may install the valve adapter. The installation process may be similar to the installation process described above with regard to FIG. 16. Once the valve adapter is installed processing may proceed to step 520.

At step 520, the user may insert the inflation tool into the dunnage bag air valve, and, at step 522, may inflate the dunnage bag using the inflation tool using the adapter. Thereafter, processing may proceed to step 524, where the user may determine whether additional gaps should be filled using a dunnage bag. If so, processing may return to step 504. If not processing may end.

It is to be understood that any given elements of the disclosed embodiments of the invention may be embodied in a single structure, a single step, a single substance, or the like. Similarly, a given element of the disclosed embodiment may be embodied in multiple structures, steps, substances, or the like.

The foregoing description illustrates and describes the processes, machines, manufactures, compositions of matter, and other teachings of the present disclosure. Additionally, the disclosure shows and describes only certain embodiments of the processes, machines, manufactures, compositions of matter, and other teachings disclosed, but, as mentioned above, it is to be understood that the teachings of the present disclosure are capable of use in various other combinations, modifications, and environments and is capable of changes or modifications within the scope of the teachings as expressed herein, commensurate with the skill and/or knowledge of a person having ordinary skill in the relevant art. The embodiments described hereinabove are further intended to explain certain best modes known of practicing the processes, machines, manufactures, compositions of matter, and other teachings of the present disclosure and to enable others skilled in the art to utilize the teachings of the present disclosure in such, or other, embodiments and with the various modifications required by the particular applications or uses. Accordingly, the processes, machines, manufactures, compositions of matter, and other teachings of the present disclosure are not intended to limit the exact embodiments and examples disclosed herein. Any section headings herein are provided only for consistency with the suggestions of 37 C.F.R. § 1.77 or otherwise to provide organizational queues. These headings shall not limit or characterize the invention(s) set forth herein.

What is claimed is:

1. A dunnage bag air valve adapter 50, comprising:
an adapter hub 201 having a valve stem contact surface 202;
an adapter rim 58 having an inflation tool contact surface 220; and
an air aperture 702 positioned between the adapter rim and adapter hub.

2. The adapter of claim 1, further comprising a coupling contact surface 203, and wherein the valve stem contact surface 202 is positioned within a diameter 211 of the adapter hub 201.

3. The adapter of claim 2, wherein the valve stem contact surface 202 is positioned adjacent to a bottom surface 210 of the adapter hub.

4. The adapter of claim 1, further comprising a coupling aperture 209, and wherein the coupling aperture is positioned within a diameter 211 of the adapter hub.

5. The adapter of claim 4, wherein the coupling contact surface 203 is positioned adjacent to a top surface 212 of the adapter hub.

6. The adapter of claim 5, wherein a portion of the adapter hub surrounding the coupling aperture is threaded.

7. The adapter of claim 1, wherein the inflation tool contact surface 220 is a top surface of the adapter rim.

8. The adapter of claim 7, wherein the inflation tool contact surface 220 comprises a surface profile corresponding to a surface 208 of a rim 105 of the inflation tool 100.

9. The adapter of claim 8, wherein the surface profile is one or more of: flat, curved, notched, slotted and grooved.

10. The adapter of claim 1, further comprising a first leg 60 connecting the adapter rim 58 with the adapter hub 201.

11. The adapter of claim 10, further comprising a second leg 62 connecting the adapter rim with the adapter hub, wherein the air aperture 702 is positioned between the first leg 60 and the second leg 62.

12. The adapter of claim 1, wherein the adapter rim is circular.

13. The adapter of claim 1, wherein the valve stem contact surface 202 is positioned within a diameter of the adapter hub.

14. A method, comprising:
providing a dunnage bag air valve adapter 50, wherein the adapter comprises an adapter hub having a valve stem contact surface 202, adapter rim 58 having an inflation tool contact surface 220, and an air aperture 702 positioned between the adapter rim and the adapter hub;
coupling the adapter to a valve stem 47 of a dunnage bag air valve 30;
placing a surface 208 of the inflation tool rim 105 in contact with the inflation tool contact surface 220; and
applying a pressure to the inflation tool contact surface via the surface of the inflation tool rim, wherein the pressure is sufficient to open the dunnage bag air valve.
